(19) United States
(12) Patent Application Publication
(10) Pub. No.: US 2018/0104805 A1
(43) Pub. Date: Apr. 19, 2018

(54) STAPLE GUN SYSTEM

(71) Applicant: JOSEPH R. RADEMAKER, DELOTONA, FL (US)

(72) Inventor: JOSEPH R. RADEMAKER, DELOTONA, FL (US)

(21) Appl. No.: 15/297,959

(22) Filed: Oct. 19, 2016

(51) Int. Cl. B25C 5/16; B25C 5/11

(52) U.S. Cl. CPC B25C 5/1679; B25C 5/11

(57) ABSTRACT

A staple gun system designed for efficiency in use, whereby a large number of staples are available to be dispensed from a cartridge mounted above the staple assembly during a single duration.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of staple guns and more specifically relates to a staple gun system.

### 2. Description of Related Art

A staple gun or powered stapler is a hand-held machine used to drive heavy metal staples into wood, plastic, or masonry. Staple guns are used for many different applications and to affix a variety of materials, including insulation, house wrap, roofing, wiring, carpeting, upholstery, and hobby and craft materials.

Some staple guns have a long nose that allows the staples to be applied into recessed corners. Another special feature may be wire guides for wiring to ensure that the staples will not pierce the wire. The “forward action” staple gun has a handle that points toward the trigger end, in the opposite direction of the traditional staple gun. These tools are easier to squeeze and better place pressure at the front of the tool where the staple is ejected.

A hammer tacker is a device somewhat similar to a staple gun, except that the mechanical energy from the user's muscles is stored, as with a hammer, as momentum of the gun itself, rather than as compression of an internal spring. This type of stapler is typically used for insulation, roofing and carpeting. For most purposes square end staples are used; but some staplers can take rounded end staples for holding cables against a surface. Conventional staple guns do not hold many staples and thus must be refilled at many increments during their use. This leads to inefficiency in work project that is not desirable.

Several attempts have been made to solve the above-mentioned problems such as those found in U.S. Patent and U.S. Publication numbers: U.S. Pat. No. 2,298,123 to George H Harred; JP200207947 to Masaya Miyazaki; and U.S. Pat. No. 2,982,966 to Dwight E. Priest. This art is representative of staple guns, and are herein incorporated by reference for their supportive teachings to assist one skilled in the art to understand the presently described invention herein. However, none of the above inventions and patents, taken either singly or in combination, is seen to describe the invention as claimed.

Preferably, a staple gun system should provide efficiency in use and, yet would operate reliably and be manufactured at a modest expense. Thus, a need exists for a reliable staple gun system to avoid the above-mentioned problems.

### BRIEF SUMMARY OF THE INVENTION

In view of the foregoing disadvantages inherent in the known staple gun art, the present invention provides a novel staple gun system. The general purpose of the present invention, which will be described subsequently in greater detail is to provide a staple gun system designed for efficiency in use, whereby a large number of staples are available to be dispensed from a cartridge during a single duration.

A staple gun system is disclosed herein, in a preferred embodiment, comprising: a staple gun assembly having a frame, a grip-handle, a bumper, a driver, a top-guide, a cartridge port, a pusher-assembly, a roller, a pivot-pin, a return-spring, a cartridge, a cartridge-plate, cartridge springs (biasing means), a dragbar, a dejammer; wherein, as such, the staple gun system comprises the staple gun assembly. Those with ordinary skill in the art will now appreciate that upon reading this specification and by their understanding the art of components of hammer staplers as described herein, methods of guiding and advancing staples, aligning staples, returning the device back to a ready position, cartridge fitment, and the like will be understood by those knowledgeable in such art.

The staple gun assembly comprises in functional combination the frame, the grip-handle, the bumper, the driver, the top-guide, the cartridge, the cartridge port, the pusher-assembly, the roller, the pivot-pin, the return-spring, the cartridge-plate, the dragbar, and the dejammer. The frame provides a cover and mounting for the bumper, the driver, the top-guide, the cartridge port, the pusher-assembly, the roller, the pivot-pin, the return-spring, the cartridge-plate, and the dragbar.

The grip-handle is located on the frame and is structured and arranged such that a user is able to suitably grip the staple gun assembly for use; the staple gun assembly used in a hammering motion to install staples. The grip-handle preferably comprises rubber and is adjacent the frame in preferred embodiments. The bumper is located adjacent the driver, and the top-guide and the cartridge port guide the staples from the cartridge during the use; the staples moved via the cartridge springs (other advancing means may be used). The cartridge springs are normally in-tension and the cartridge springs, when in-tension advance the staples one by one. The pusher-assembly is used to advance the staples and the roller removably couples the top-guide and the cartridge port guide together for use. Various pusher-assemblies (means for advancing via spring pressure or other) may be used in alternate embodiments. The pivot-pin allows rotation of the frame in relation to the cartridge-plate. The pivot-pin allows the top-guide and the cartridge port guide to move in relation to the frame.

The return-spring acts in relation to the frame and the top-guide such that the top-guide is able to return to a normal-ready-for-use-position after the staple has been dispensed. The return-spring is normally in-tension. The cartridge-plate and the dragbar maintain positioning of the staples when feeding the staples with the pusher-assembly having a charger in certain embodiments. The dejammer is located on the frame and is structured and arranged to un-jam the staples during use (when a staple becomes jammed). The dejammer is located at the front-end of the frame and relationally speaking the dejammer is opposed to the charger (on the opposite end of the frame). This positioning is such that it is adjacent staples that may need to be un-jammed. The bumper controls movement of the return-spring with the staples being aligned on the cartridge plate and the dragbar for appropriate manipulation.

The staple gun assembly in combination with the cartridge is structured and arranged to provide a continuous feed of the staples for an extended duration. The cartridge is able to hold and feed at least 5000 staples for use. Embodiments may dispense different sized staples.

The present invention holds significant improvements and serves as a staple gun system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, staple gun system, constructed and operative according to the teachings of the present invention.

FIG. 1 shows a perspective view illustrating a staple gun system comprising a staple gun assembly during an ‘in-use’ condition showing a user hammer tacking via staples according to an embodiment of the present invention.

FIG. 2 is a perspective view illustrating the staple gun assembly according to an embodiment of the present invention of FIG. 1.

FIG. 3 is a perspective view illustrating the staple gun assembly according to an embodiment of the present invention.

FIG. 4 shows the staple gun assembly according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a stapling means and more particularly to a staple gun system as used to improve the efficiency of stapling on work projects such as insulating or the like.

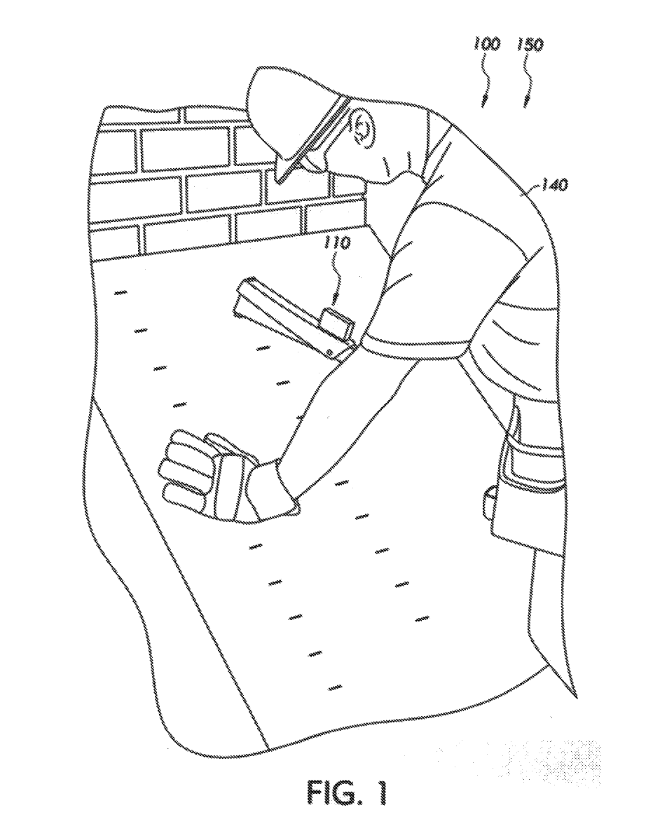

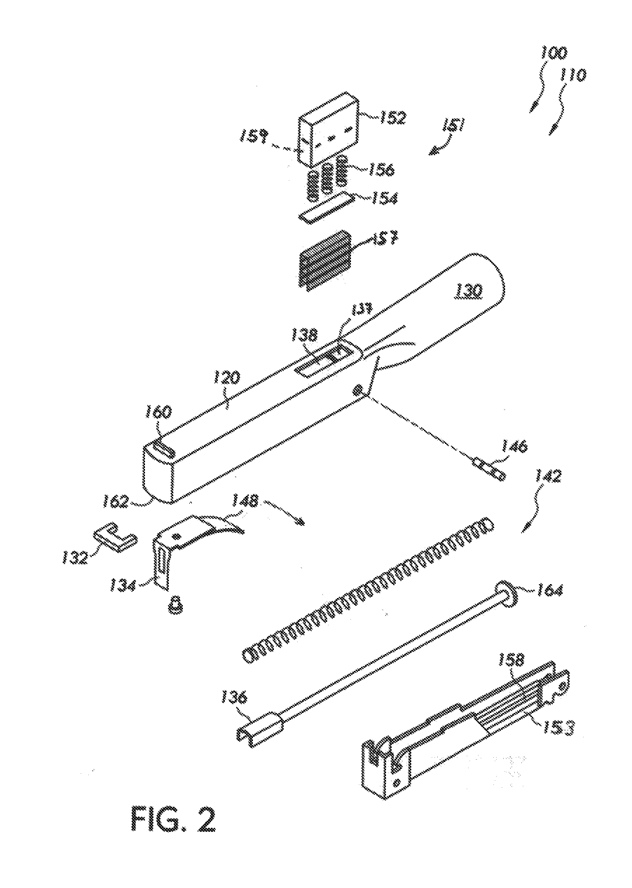

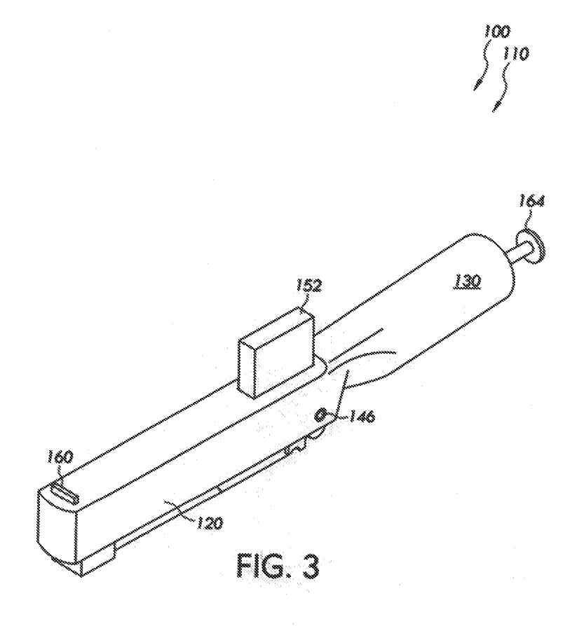

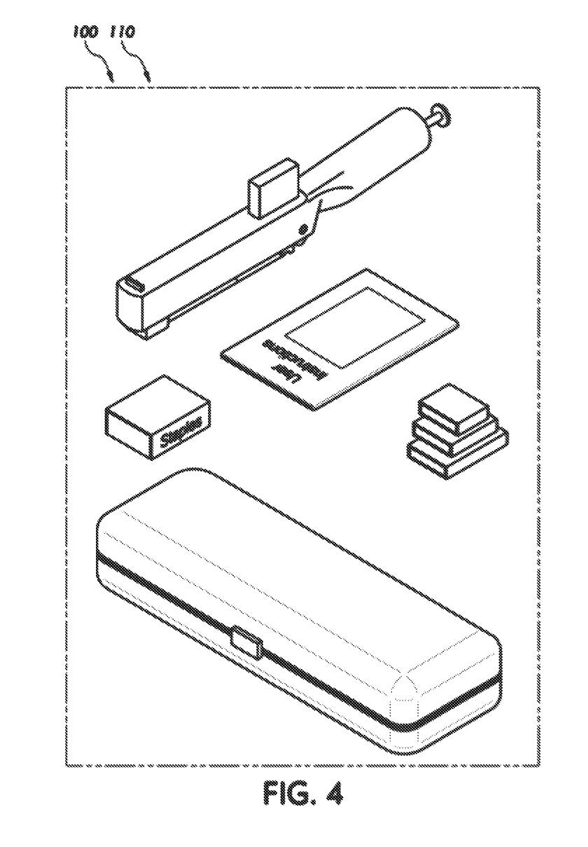

Referring to the drawings by numerals of reference there is shown in FIGS. 1-4, various views of staple gun system 100 comprising: staple gun assembly 110 having a frame 120 with a grip-handle 130 (located at a back end of the frame 120), housed within and on the frame 120 are various parts, like: a bumper 132, a driver 134, top-guide 136, cartridge port 138 (housed on a middle section of the frame 120), pusher-assembly 142, roller (in certain embodiments), pivot-pin 146, return-spring 148, removable cartridge 152 (also referred to as cartridge housing, cartridge-plate 154, cartridge springs 156, dragbar 158, and dejammer 160. As such, staple gun system 100 comprises staple gun assembly 110.

The staple placement mechanism, located at a front end of the frame 120, is made up of the operational parts including the bumper 132, the driver 134, the dejammer 160, and a cartridge port guide 162, and is designed to extract a staple form within the staple gun frame and place it into a desired object.

The cartridge assembly 152 is made up of the cartridge housing 152, the springs (biasing devices) 156, the cartridge plate 145, and a cavity (not shown or numbered) within the cartridge housing 152 and below the cartridge plate 145, for storing the sets of staples (which are illustrated but not a claimed part of the invention). Thus, the assembly is designed to push one staple set at a time into the frame 120, through the cartridge port 138 and onto the dragbar 158, whereby the top-guide 136 will force the new staple set toward the bumper 132 to be ejected from the staple gun in a known fashion.

Staple gun assembly 110 comprises in functional combination frame 120, grip-handle 130, bumper 132, driver 134, top-guide 136, cartridge 152, cartridge port 138, pusher-assembly 142, roller, pivot-pin 146, return-spring 148, cartridge-plate 154, dragbar 158, and dejammer 160. Frame 120 provides a cover and mounting for bumper 132, driver 134, top-guide 136, cartridge port 138, pusher-assembly 142, roller, pivot-pin 146, return-spring 148, cartridge-plate 154, and dragbar 158.

Referring now to grip-handle 130; grip-handle 130 is located on a back portion of the frame 120 and is structured and arranged such that a user is able to suitably grip staple gun assembly 110 for use. Staple gun assembly 110 can also be used in a hammering motion to install staples. Bumper 132 is located adjacent driver 134. Top-guide 136 and cartridge port guide 162 staples from cartridge 152 during use and staples are moved via cartridge springs 156.

Pusher-assembly 142 is used to advance staples. Roller removably couples top-guide 136 and cartridge port guide 162 together for use. Pivot-pin 146 allows top-guide 136 and cartridge port guide 162 to move in relation to frame 120. Return-spring 148 acts in relation to frame 120 and top-guide 136 such that top-guide 136 is able to return to a normal-ready-for-use-position after at least one staple has been dispensed. Cartridge-plate 154 and dragbar 158 maintain positioning of staples when feeding staples. Dejammer 160 is located on frame 120 and is structured and arranged to un-jam the staples during use. Bumper 132 controls movement of return-spring 148 that may be mounted along, over, or around an elongated section connected between the charger 164 and the top-guide 136.

Staples are aligned on the cartridge plate 154 and dragbar 158 for sliding the staples therealong toward the bumper 132. Staple gun assembly 110 in combination with cartridge 152 is structured and arranged to provide a continuous feed of staples for an extended duration. Cartridge 152 is able to hold and feed at least 2600 staples for use. Pusher-assembly 142 may comprise charger 164 in certain embodiments. Whereby, after the last staple loaded on dragbar 158 has been used, a user will pull back the charger 164 so that the top-guide slides past the cartridge port 138 thus allowing a new set of staples from cartridge 152 (from the force of the springs 156), to drop in front of the top-guide 136 onto the dragbar 158, and thus be fully recharged. Grip-handle 130 comprises rubber and is adjacent frame 120. Dejammer 160 is located at a front-end of frame 120. Pivot-pin 146 allows rotation between the frame 120 in relation to bottom-frame 154. Wherein, the bottom frame 154 is designed to support the dragbar 158, and house the charger, and pusher assembly pieces 148, 136, 164 in a known fashion. Note that, return-spring 148 is normally in-tension; and cartridge springs 156 are also normally in-tension.

Cartridge springs 156 when in-tension advance the staple sets one by one into the frame 120, through the cartridge port 138, and onto the dragbar 158. In other words, the cartridge spring 156 (or biasing device) is positioned between a portion of the cartridge housing and cartridge plate to bias the cartridge plate away from one interior end of the cartridge housing and toward the interior of the frame. Dejammer 160 is located opposed to charger 164. In one embodiment, cartridge 152 is able to hold and feed at least 5000 staples for use in certain embodiments. In another embodiment, cartridge 152 is able to hold and feed at least 7000, 8000, 9000 and 10,000 staples for use in other embodiments. Larger capacity embodiments are envisioned to hold more staples as per job application. Cartridge springs 156 may be linearly placed in relation to each other. Cartridge 152 comprises a length of 2½ inches in preferred embodiments; other lengths may be used in alternate embodiments.

It should be noted that staple gun system 100 may be sold as a kit comprising the following parts: at least one staple gun assembly 110; at least one set of staples; at least one carrying container; and at least one set of user instructions. The kit has instructions such that functional relationships are detailed in relation to the structure of the invention (such that the invention can be used, maintained, or the like in a preferred manner). Staple gun system 100 may be manufactured and provided for sale in a wide variety of sizes and shapes for a wide assortment of applications, and staple sizes. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different cartridge combinations, parts may be sold separately, etc., may be sufficient.

A method of use for staple gun system 100 (of staple gun system 100) according to an embodiment of the present invention comprises the steps of step one holding staple gun assembly 110; step two loading staple gun assembly 110 with cartridge 152; manipulating and dispensing staples into at least one work product. Step three may comprise reloading staples into cartridge 152 and step four may comprise inserting a full cartridge 152 into staple gun assembly 110 for use.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

It is noted that one advantage of the present design is that of the cartridge assembly. Specifically, the whole assembly is removable from the staple gun. Whereby, once all of the staple sets are gone, a user can remove the cartridge assembly and place new staple sets therein, in a sufficient amount to total hundreds of staples, even totaling up to 5000 or more. Whereby, a skilled artisan will realize that there will need to be a releasably locking or holding mechanism of some sort to removably hold the cartridge assembly thereto the frame when in operation, however, one such holding mechanism is not illustrated.

It is further noted, the cartridge assembly 152 is designed to retain many staple sets up and away from the interior of the frame 120, and especially away from the dragbar 158.

It is additionally noted, the staple sets are held up away from the dragbar 158xxx

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A staple gun system, comprising:
a staple gun assembly having: a frame; a grip-handle; a bumper; a driver; a top-guide; a cartridge port; a pusher-assembly; a roller; a pivot-pin; a return-spring; a cartridge; a cartridge-plate; a cartridge springs; a dragbar; and a dejammer;
wherein said staple gun system comprises said staple gun assembly;
wherein said staple gun assembly comprises in functional combination said frame, said grip-handle, said bumper, said driver, said top-guide, said cartridge, said cartridge port, said pusher-assembly, said roller, said pivot-pin, said return-spring, said cartridge-plate, said dragbar, and said dejammer;
wherein said frame provides a cover and mounting for said bumper, said driver, said top-guide, said cartridge port, said pusher-assembly, said roller, said pivot-pin, said return-spring, said cartridge-plate, said dragbar;
wherein said grip-handle is located on said frame and is structured and arranged such that a user is able to suitably grip said staple gun assembly for use, said staple gun assembly used in a hammering motion to install staples;
wherein said bumper is located adjacent said driver;
wherein said top-guide and said cartridge port guide said staples from said cartridge during said use, said staples moved via said cartridge springs;
wherein said pusher-assembly is used to advance said staples;
wherein said roller removably couples said top-guide and said cartridge port guide together for use;
wherein said pivot-pin allows said top-guide and said cartridge port guide to move in relation to said frame;
wherein said return-spring acts in relation to said frame and said top-guide such that said top-guide is able to return to a normal-ready-for-use-position after said staple has been dispensed;
wherein said cartridge-plate, said dragbar maintain positioning of said staples when feeding said staples;
wherein said dejammer is located on said frame and is structured and arranged to un-jam said staples during said use;
wherein bumper controls movement of said return-spring;
wherein said staples are aligned on said cartridge plate and said dragbar; and
wherein said staple gun assembly in combination with said cartridge is structured and arranged to provide a continuous feed of said staples for an extended duration, said cartridge able to hold and feed at least 2600 said staples for use.

2. The staple gun system of claim 1 wherein said pusher-assembly further comprises a charger.

3. The staple gun system of claim 1 wherein said grip-handle comprises rubber and is adjacent said frame.

4. The staple gun system of claim 1 wherein said dejammer is located at a front-end of said frame.

5. The staple gun system of claim 1 wherein said pivot-pin allows rotation of said frame in relation to said cartridge-plate.

6. The staple gun system of claim 1 wherein said return-spring is normally in-tension.

7. The staple gun system of claim 1 wherein said cartridge springs are normally in-tension.

8. The staple gun system of claim 7 wherein said cartridge springs when in-tension advance said staples one by one.

9. The staple gun system of claim 2 wherein said dejammer is located opposed to said charger.

10. The staple gun system of claim 1 wherein said cartridge is able to hold and feed at least 5000 said staples for use.

11. The staple gun system of claim 1 wherein said cartridge is able to hold and feed at least 7000 said staples for use.

12. The staple gun system of claim 1 wherein said cartridge is able to hold and feed at least 8000 said staples for use.

13. The staple gun system of claim 1 wherein said cartridge is able to hold and feed at least 9000 said staples for use.

14. The staple gun system of claim 1 wherein said cartridge is able to hold and feed at least 10000 said staples for use.

15. The staple gun system of claim 1 wherein said cartridge springs are linearly placed in relation to each other.

16. The staple gun system of claim 1 wherein said cartridge comprises a length of 2½ inches.

17. A staple gun system, comprising:
a staple gun assembly having; a frame; a grip-handle; a bumper; a driver; a top-guide; a cartridge port; a pusher-assembly; a roller; a pivot-pin; a return-spring; a cartridge; a cartridge-plate; a cartridge springs; a dragbar; and a dejammer;
wherein said staple gun system comprises said staple gun assembly;
wherein said staple gun assembly comprises in functional combination said frame, said grip-handle, said bumper, said driver, said top-guide, said cartridge, said cartridge port, said pusher-assembly, said roller, said pivot-pin, said return-spring, said cartridge-plate, said dragbar, and said dejammer;
wherein said frame provides a cover and mounting for said bumper, said driver, said top-guide, said cartridge port, said pusher-assembly, said roller, said pivot-pin, said return-spring, said cartridge-plate, said dragbar;
wherein said grip-handle is located on said frame and is structured and arranged such that a user is able to suitably grip said staple gun assembly for use, said staple gun assembly used in a hammering motion to install staples;
wherein said grip-handle comprises rubber and is adjacent said frame;
wherein said bumper is located adjacent said driver;
wherein said top-guide and said cartridge port guide said staples from said cartridge during said use, said staples moved via said cartridge springs;
wherein said cartridge springs are normally in-tension;
wherein said cartridge springs when in-tension advance said staples one by one;
wherein said pusher-assembly is used to advance said staples;
wherein said roller removably couples said top-guide and said cartridge port guide together for use;
wherein said pivot-pin allows rotation of said frame in relation to said cartridge-plate;
wherein said pivot-pin allows said top-guide and said cartridge port guide to move in relation to said frame;
wherein said return-spring acts in relation to said frame and said top-guide such that said top-guide is able to return to a normal-ready-for-use-position after said staple has been dispensed;
wherein said return-spring is normally in-tension;
wherein said cartridge-plate, said dragbar maintain positioning of said staples when feeding said staples;
wherein said pusher-assembly comprises a charger;
wherein said dejammer is located on said frame and is structured and arranged to un-jam said staples during said use;
wherein said dejammer is located at a front-end of said frame;
wherein said dejammer is opposed to said charger;
wherein bumper controls movement of said return-spring;
wherein said staples are aligned on said cartridge plate and said dragbar; and
wherein said staple gun assembly in combination with said cartridge is structured and arranged to provide a continuous feed of said staples for an extended duration, said cartridge able to hold and feed at least 5000 said staples for use.

18. A continuously fed staple gun, comprising:
a. a frame;
b. a grip-handle at a back end of the frame;
c. a staple placement mechanism, positioned at a front end of the frame, designed to eject staples from the staple gun in place the staples into a desired object;
d. a cartridge assembly positioned between the grip-handle and staple placement mechanism, and is releasably attached to an exterior side of the frame, designed to store multiple staple sets that are not in physical contact with the interior of the frame, having:
i. a cartridge housing;
ii. a cartridge plate, positioned within the cartridge housing;
iii. a biasing device positioned between a portion of the cartridge housing and cartridge plate to bias the cartridge plate a way from one interior end of the cartridge housing and toward the interior of the frame; and
iv. a cavity located below the cartridge place sufficiently designed to hold one or more staple sets;
d. a pusher assembly, posited within the frame, designed to receive a staple set from the cartridge assembly, and thereby move a staple set from the cartridge assembly to the staple placement mechanism while leaving the stored staple sets in the cartridge assembly.

19. The continuously fed staple gun of claim 18, wherein the staple placement mechanism, includes a bumper, a driver, a dejammer, and a cartridge port guide, and is designed to extract a staple form within the staple gun frame and place it into a desired object.
